(19) United States
(12) Patent Application Publication
(10) Pub. No.: US 2009/0048983 A1
(43) Pub. Date: Feb. 19, 2009

(54) USER INTERFACE FOR TREND PREDICTING IN A TRADING MARKET

(76) Inventor: Lowell F. Witter, Elgin, IL (US)

Correspondence Address: BRINKS HOFER GILSON & LIONE, P.O. BOX 10395, CHICAGO, IL, 60610, US

(21) Appl. No.: 12/193,503

(22) Filed: Aug. 18, 2008

Related U.S. Application Data
(60) Provisional application No. 60/956,213, filed on Aug. 16, 2007.

(51) Int. Cl. G06Q 40/00

(52) U.S. Cl. 705/36 R

(57) ABSTRACT

Changes in trading trends are indicated. An indicator, such as a bar, is displayed adjacent to the trend line. The indicator persists the trend to a greater extent than the trend line. As the trend line changes, the indicator more gradually changes or does not change. The difference in values, such as slope of the indicator relative to the trend line, indicates the change in trend.

### RELATED APPLICATIONS

The present patent document claims the benefit of the filing date under 35 U.S.C. §119(e) of Provisional U.S. Patent Application Ser. No. 60/956,213, filed Aug. 16, 2007, which is hereby incorporated by reference.

### BACKGROUND

This present invention relates to charting in a trading market. In particular, charting is used to predict trends in pricing.

Pricing in a commodity, stock, or other asset may be charted. The chart is formed from a series of candles. Each candle represents a period, such as minutes, hours, or days. Each candle is a vertical bar or line representing the high and low during the period. The chart provides an indication of the past trading associated with the commodity.

To assist viewers in predicting future pricing, one or more trend lines may be generated. The trend line represents an average, high, low, or other price as a function of time. A line is fit to the pricing over a period longer than the period used for the candles. Different trend lines may reflect the pricing trend over different periods, such as the last 24 hours, the last 5 days, or the last month. As a new candle is added, the trend line is updated. However, the changes to the trend line may be subtle. A viewer may not perceive the change.

### BRIEF SUMMARY

By way of introduction, the preferred embodiments described below include methods, systems, computer readable media, and instructions for indicating changes in trading trends. An indicator, such as a bar, is displayed adjacent to the trend line. The indicator persists the trend to a greater extent than the trend line. As the trend line changes, the indicator more gradually changes or does not change. The difference in values, such as slope of the indicator relative to the trend line, indicates the change in trend.

In a first aspect, a system is provided for indicating changes in trading trends. A processor is operable to generate a candle chart with a trend line and an indicator. The processor is operable to vary the trend line. The indicator indicates a change in the trend line. A display is operable to display the candle chart.

In a second aspect, a computer readable storage medium has stored therein data representing instructions executable by a programmed processor for indicating changes in trading trends. The storage medium includes instructions for generating a chart of pricing as a function of time, displaying, as a function of time, a first trend of the pricing with the chart, and displaying a persisted trend simultaneously with the first trend of the pricing.

In a third aspect, a method of indicating changes in trading trends is provided. A trend line of a trading chart is displayed. The trend line represents a trend over a first period. An indicator is displayed adjacent the trend line. The indicator is a function of a previous one of the trends over the first period.

The present invention is defined by the following claims, and nothing in this section should be taken as a limitation on those claims. Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a graphical representation of one embodiment of a chart with trending lines and a trend change indicator;

FIG. 2 is a flow chart diagram of a method, according to one embodiment, for indicating a change in a trading trend; and

FIG. 3 is a block diagram of a system for indicating a change in a trading trend, in one embodiment.

### DETAILED DESCRIPTION OF THE DRAWINGS AND PRESENTLY PREFERRED EMBODIMENTS

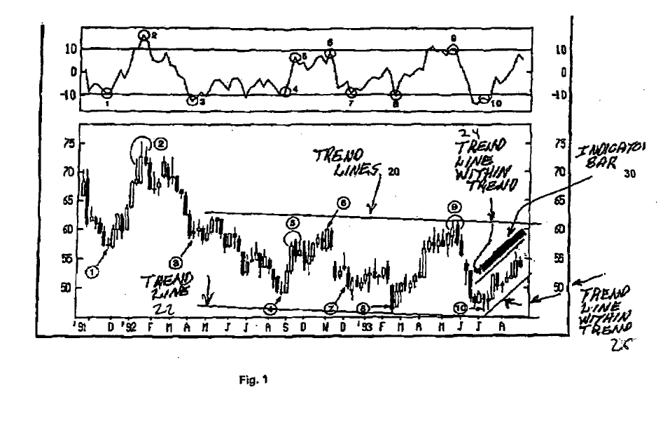

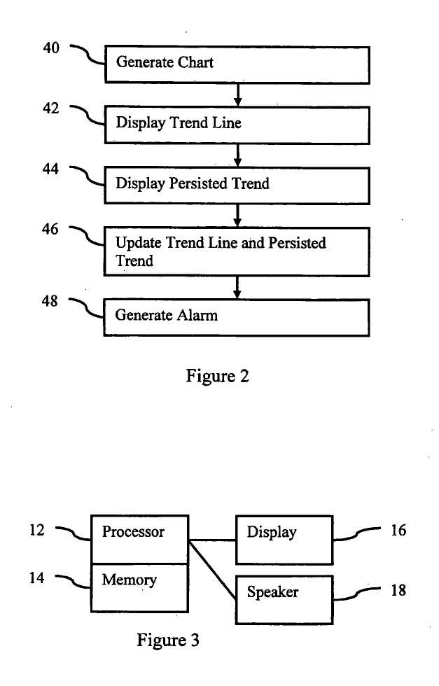

FIG. 1 shows one embodiment of a trading volume and price chart. FIG. 2 shows a method of indicating changes in trading trends. The method provides an indicator, such as the indicator shown at 30 in FIG. 1, of persisted or past trends to indicate a change in trend. The method of FIG. 2 is implemented with the system of FIG. 3, but a different system may be used. The method of FIG. 2 provides the chart of FIG. 1, but different charting, trend indicators, and/or change in trend indicators may be used. The method is performed in the order shown or a different order.

In act 40, a chart is generated. The chart shows pricing as a function of time, such as a candle chart. Prices are tracked, such as using data output by a market. The prices are used to generate the chart. Any charting program may be used. The candles are generated by a computer. Software, hardware, firmware, or other components generate the candle chart on the display. Any now known or later developed charting program may be used. Trading information is received and used to generate the chart. Instructions for generating the chart are stored in computer readable media, such as ROM, RAM, cache, hard drive, optical media, magnetic media, or other memory device. The processor, memory, and display are used to provide the chart and associated information discussed herein. Any type of charting may be used. The trading volume may or may not also be shown.

FIG. 1 shows one embodiment of a candle chart for tracking trading volume and pricing as a function of time. Candle charts may be used for any traded commodity, stock, or other instrument. Candle charts may track any desired period, such as each candle representing a tick, 1 minute, 5, 10, 15, 20, 60 minutes, daily, weekly, monthly or other periods.

In act 42 of FIG. 2, one or more trend lines are displayed. The trend lines are displayed on the chart, adjacent to the chart, or separate from the chart. The trend line represents a trend in pricing over a period. The trend line represents the pricing at different times. Any trend display may be used.

In the example of FIG. 1, the chart includes one or more trend lines 20, 22, 24, 26. In one embodiment, a single trend line is determined. A mirror trend line may be provided, such as providing the trend lines 20, 22 above and below the candles of the chart. The trend lines 20, 22 represent a trend in price over a period of time. Any formula may be used for trending, such as fitting a line to the average price for each candle. Volume, variance or other weighting may be used.

The trend lines 20, 22 are parallel and on each side of the candles. In other embodiments, the trend lines 20, 22 are different, such as being calculated based on a different formula or information. For example, the upper trend line 20 is based on the high prices, and the lower trend line is based on the low prices.

Trend lines 24, 26 within trends may be calculated and displayed. The trend lines 24, 26 within the trend lines 20, 22 represent a shorter term trend. A single trend within a trend may be displayed. In other embodiments and as shown, the trend lines 24, 26 within the trends are provided on each side of the candles. The lines 24, 26 are parallel or may be different. The trend lines 24, 26 are for any length of time less than used to determine the major or long period trend lines 20, 22. The trend lines 24, 26 within the trend show the most recent trend or are for the most recent data. The trend lines 24, 26 within the trend lines 20, 22 are for the most recent candles or prices. The trend lines 24, 26 within the trend lines 20, 22 may be for other periods than the most recent period.

The trend lines 20, 22, 24, and 26 are updated as a function of time. As each new candle is added, the trend lines 20, 22 and/or the trend lines 24, 26 with the trends may be recalculated. The recalculation uses a temporally moving window of the most recent pricing. As a new candle is added for the trend line fitting, the oldest candle is removed from the fitting calculation. Subsequent images, such as in a scrolling format, have the new or adjusted trend lines 20, 22, 24, and/or 26 displayed. The slope, position, length, or other characteristic of the trend lines varies due to the recalculation. Less frequent updates may be provided, such as updating the trend lines periodically, after a number of candles greater than one, or based on other triggers.

Trend lines 20, 22, 24, and 26 are provided as examples of trend. Other indications of trend may be used, such as numerical values, bar graphs, or pie charts.

In act 44 of FIG. 2, a persisted trend is displayed. The persisted trend is displayed simultaneously with the trend of the pricing. The persisted trend represents the same trend, at least partially, of the past. The shift of trend lines due to recalculation may be subtle or not easily noticed. A further source of information provides an indication of the change in trend. The indication may be numerical (e.g., slope difference) or graphical. For example, the previous trend lines and current trend lines are shown simultaneously, but in different colors, dashing, or other difference in display.

The persisted trend is calculated as a function of the trend. The persisted trend is the same trend but for an earlier time. The most recent update of the trend is not included in the persisted trend. The persisted trend is a previous trend calculated for pricing over a substantially same length of time as the first trend. The persisted trend is for the same period, but a different time than the currently displayed trend. Alternatively, the persisted trend may be determined for pricing over a longer period, such as both the persisted trend and the trend having a same start time, but different end time. The persisted trend is calculated in the same way as the trend, but updated less frequently than the trend. In other embodiments, the persisted trend is determined as a function of a previous trend, such as being a previous calculation for the same trend (e.g., same length of time, but over a different overlapping, such as by half, range of times).

One example embodiment is shown in FIG. 1. An indicator bar or line 30 is provided. The indicator bar 30 is adjacent, but spaced slightly from, the trend line 20, 22, 24, and/or 26. The indicator 30 may be at a similar position relative to the trading chart as the trend line, such as substantially overlapping along the horizontal and vertical axes of the chart and/or being at least partly by a same peak or valley of the candles of the chart. The indicator bar 30 may have a similar length as the trend line, such as being associated with a same or substantially same period as the trend line. Substantially is used to account for a difference in update interval of the indicator bar 30 as compared to the trend line. Alternatively, the indicator bar 30 is adjacent by overlapping, intersecting, or being around at least a portion of the trend line 20, 22, 24 and/or 26, such as being a box with different color or shading. In other embodiments, the indicator bar 30 is shorter than the trend line 20, 22, 24, and/or 26.

The indicator bar 30 may be a line, a bar/box, or other graphical element. As a bar, the indicator bar 30 may be solid or have lines on four sides and open in the center. The center may be colored. The color or other characteristic of the indicator bar 30 may change based on pricing and/or volume information. For example, the difference in slope between the indicator bar 30 and the current trend line 24 determines the color. As the trend line 24 changes slope, the variance in distance between the trend line 24 and the indicator bar 30 also changes. This difference in spacing provides a visual indication of the change in trend.

In the embodiment shown, a single indicator bar 30 above one trend line 24 is provided. In other embodiments, indicator bars 30 may be provided for both related trend lines (e.g., 24 and 26) or longer term trend lines 20, 22. The indicator bars 30 are positioned to avoid interference with the candles, such as above trend line 24 and below trend line 26. In another embodiment, the indicator bar 30 may be automatically repositioned to avoid interference. For example, subsequent candles have a rapidly increasing high. As a result, the trend line 24 has an increasing slope causing the trend line 24 to intersect or form over part of the indicator bar 30. To provide visual separation, the indicator bar 30 may be repositioned to the bottom trend line 26. Alternatively, the overall spacing is changed or the intersection is allowed to occur, such as with differences in color avoiding confusion.

The indicator bar 30 has a slope indicative of a past trend, such as the most recently past trend or a past trend within the update period of the indicator bar 30. The indicator bar 30 maintains a position and/or slope for a longer period or for a different time than the corresponding trend line (e.g., trend 24). The update to reposition or change the slope of the indicator bar 30 is based on user triggering/input, a period (e.g., 5 candles), or other trigger. For example, to reset the indicator bar 30, the user clicks on an icon at the top of the monitor screen. The indicator bar 30 will then be reset along side of the trend line 24. As another example, the indicator bar 30 is updated at a same frequency, but using data one, two or more time increments behind the current trend. The difference in slope between the indicator bar 30 and the trend line 24 indicates the change of the trend line 24. For example, the extent to which the indicator bar 30 and the trend line 24 are not parallel indicates the change in trend of the trend line 24.

In act 46 of FIG. 2, the persisted trend and the trend are updated. When a new candle appears on the chart or is determined, the trend line 24 within the trend may change. The other trend lines may change. The indicator bar 30 may not move as the trend line 24 moves since the trend line is updated less frequently. One end of trend line 24 moves closer to the indicator bar 30, while the other end of the trend line 24 is at a same position or moves away from the indicator bar 30. This lets a user see the direction the trend is moving, up, down or sideways. In other embodiments, the persisted trend moves differently than the current trend, indicating the change in trend. For example, the indicator bar 30 is the trend determined one, two, or more candles in the past. As a new candle is added, the window for the persisted trend shifts by one candle. The trend lines 20, 22, 24, and 26 are updated to include the new candle, and the persisted trend is updated for the trend from an offset time in the past. The update is at a same or different frequency. The update of the trend lines and/or the persisted trend is ongoing as the chart is created or as candles are added.

The user may select a different chart. For example, each candle corresponds to an hour. The user may desire the candles to represent 30 minutes in order to identify higher frequency variation or trends. For the new chart, new trend lines and indicators or persistent trend are calculated. The persistent trend is the same as the new trend lines. Alternatively, historical information is used to determine the persisted trend as if the charting has been on going.

In act 48 of FIG. 2, an alarm is generated for a change in direction of a slope of the trend line, the indicator, or both. For example, if the trend line or the indicator bar change from increasing to decreasing slope, or vise versa, an alarm is generated. Alternatively, if the trend line has a different direction of slope than the persisted trend, an alarm is generated. A threshold difference in slope, a threshold change in slope even if not with a change in direction, or other limitations may be used to trigger an alarm.

The alarm is a visual and/or audio alarm. For example, the indicator bar 30 changes color or flashes. As another example, a beep or other audio signal is output.

FIG. 3 shows a system for indicating changes in trading trends. The system implements the method of FIG. 2 or a different method. The system outputs the type of chart shown in FIG. 1 or a different type of chart.

The system is a computer, workstation, trading station, handheld device, personal data assistant, cell phone, or other computer. The system includes a processor 12, a memory 14, a display 16, and a speaker 18. Additional, different, or fewer components may be provided. For example, the speaker 18 is not provided.

The processor 12 is a general processor, digital signal processor, application specific integrated circuit, field programmable gate array, digital circuit, analog circuit, combinations thereof, or other now known or later developed device for charting. The processor 12 generates a candle chart with a trend line and an indicator. The indicator is a line or bar positioned parallel to the trend line prior to varying the trend line, but may have a non-parallel starting position where historical information is available. The processor 12 varies the trend line as time progresses. The indicator indicates a change in the trend line. For example, the indicator indicates change by a difference in spacing between the indicator and the varied trend line. The indicator indicates the change by maintaining a position relative to the varying trend line.

The processor 12 may generate an alarm for a change in slope of the trend line, the indicator, or both. The alarm is a visual indicator on the display 16 and/or an audio signal from the speaker 18.

The display 16 is a CRT, LCD, plasma display, projector, printer, or other chart output device. The display 16 displays the candle chart, the trend lines, and/or the indicator.

The memory 14 is a computer readable storage medium. The instructions for implementing the processes, methods and/or techniques discussed above are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I(We) claim:

1. A system for indicating changes in trading trends, the system comprising:
a processor operable to generate a candle chart with a trend line and an indicator, and operable to vary the trend line, the indicator indicating a change in the trend line; and
a display operable to display the candle chart.

2. The system of claim 1 wherein the indicator is a line or bar positioned parallel to the trend line prior to varying the trend line, and wherein the indicator indicates change by a difference in spacing between the indicator and the varied trend line.

3. The system of claim 1 wherein the indicator indicates the change by maintaining a position relative to the varying trend line.

4. The system of claim 1 wherein the processor is operable to generate an alarm for a change in slope of the trend line, the indicator, or both.

5. The system of claim 4 wherein the alarm comprises a visual indicator on the display.

6. The system of claim 4 further comprising a speaker, wherein the alarm comprises an audio signal from the speaker.

7. In a computer readable storage medium having stored therein data representing instructions executable by a programmed processor for indicating changes in trading trends, the storage medium comprising instructions for:
generating a chart of pricing as a function of time;
displaying, as a function of time, a first trend of the pricing with the chart; and
displaying a persisted trend simultaneously with the first trend of the pricing.

8. The computer readable storage medium of claim 7 wherein displaying the persisted trend comprises calculating the persisted trend as a function of the first trend without a most recent update of the first trend.

9. The computer readable storage medium of claim 7 wherein displaying the persisted trend comprises displaying the persisted trend as a function of a same period and different time of the pricing than the trend.

10. The computer readable storage medium of claim 7 wherein displaying the persisted trend comprises updating the persisted trend less frequently than the first trend.

11. The computer readable storage medium of claim 7 wherein displaying the persisted trend comprises displaying the persisted trend as a previous trend calculated for pricing over a substantially same length of time as the first trend.

12. The computer readable storage medium of claim 7 wherein displaying the persisted trend comprises displaying the persisted trend adjacent to the first trend such that a change in slope of the first trend is indicated relative to the persisted trend.

13. The computer readable storage medium of claim 12 wherein adjacent comprises parallel except for the change in slope and having a substantially similar length.

14. The computer readable storage medium of claim 12 wherein displaying the first trend comprises displaying a trend line and wherein displaying the persisted trend comprises displaying an indicator line or bar.

15. The computer readable storage medium of claim 7 wherein displaying the persisted trend comprises indicating a change in the first trend.

16. A method of indicating changes in trading trends, the method comprising:
displaying a trend line of a trading chart, the trend line representing a trend over a first period; and
displaying an indicator adjacent the trend line, the indicator being a function of a previous one of the trends over the first period.

17. The method of claim 16 wherein displaying the indicator comprises displaying a line or bar having a slope of the previous one of the trends, a difference between the slope of the previous one and a current one of the trends indicated by non-parallel display of the indicator and trend line.

18. The method of claim 16 wherein displaying the indicator comprises displaying the indicator as spaced from the trend line, at a similar position relative to the trading chart as the trend line, and having a similar length as the trend line.

19. The method of claim 16 further comprising:
updating the indicator, but less frequently than updating the trend line.

20. The method of claim 16 further comprising:
generating an alarm for a change in direction of a slope of the trend line, the indicator, or both.
